(19) United States
(12) Patent Application Publication
(10) Pub. No.: US 2014/0361573 A1
(43) Pub. Date: Dec. 11, 2014

(54) Ornamental Vehicle Floor Mat Cover

(71) Applicant: Janet Perkins, Matthews, NC (US)

(72) Inventor: Janet Perkins, Matthews, NC (US)

(21) Appl. No.: 14/296,675

(22) Filed: Jun. 5, 2014

Related U.S. Application Data
(60) Provisional application No. 61/833,267, filed on Jun. 10, 2013.

(51) Int. Cl. B60N 3/04

(52) U.S. Cl. CPC B60N 3/048
USPC 296/97.23

(57) ABSTRACT

Disclosed is an ornamental floor mat cover for vehicles that provides a decorative appearance while concealing the underlying floor mat of a vehicle. The device includes an upper layer and a lower layer, wherein the upper layer may having various patterns or designs thereon. The lower layer includes a high friction surface and one or more pockets disposed thereon. The pockets are adapted to receive ends of a floor mat so that the cover is removably attached to the floor mat. In this way, the present device provides a vehicle floor mat cover with various designs, while concealing the presence of the existing vehicle floor mat. The device may be easily installed and removed, while protecting the existing vehicle floor mat to prolong the use thereof.

### CROSS REFERENCE TO RELATED APPLICATION

This application claims the benefit of U.S. Provisional Application No. 61/833,267 filed on Jun. 10, 2013. The above identified patent application is herein incorporated by reference in its entirety to provide continuity of disclosure.

### BACKGROUND OF THE INVENTION

1. Field of the Invention

The present invention relates to an ornamental accessory and a cover for vehicle floor mats. More specifically, the present invention pertains to a covering for a vehicle floor mat having a decorative upper surface and a non-slip lower surface. The present vehicle floor mat is ideal for use with various types of vehicle floor mats.

A vehicle floor mat is an accessory for the interior of a vehicle that is generally included with the purchase of a vehicle and are supplied by the vehicle's manufacturer. Vehicle floor mats are designed to protect the floor of a vehicle from dirt, wear, and salt corrosion. Although most mats can be removed for cleaning, it is often impracticable to maintain the appearance of a mat over its lifetime.

Additionally, conventional vehicle floor mats generally come in plain, dark colors, and are styled to blend in with the floor of the vehicle. Plain colors and styles, however, may not be suitable for an individual's style preferences, and may limit the individual from customizing the interior of his or her vehicle. Therefore, many individuals desire creative new ways to enhance the look of the vehicle interior.

The present invention provides a decorative cover for vehicle floor mats. The device may be used with existing vehicle floor mats, or may be used as a floor mat for vehicles with no floor mats. By covering the floor mat, the present invention allows a user to customize the look of the interior of the vehicle. The primary advantage of the present invention is not only its decorative design, but more specifically the pockets that facilitate the installation of the device.

2. Description of the Prior Art

Devices have been disclosed in the prior art that relate to vehicle floor mats, and further to those adapted to prolong the use of existing vehicle floor mats by protecting the same. These include devices that have been patented and published in patent application publications. Some of these patents describe a vehicle floor mat cover having a single pocket for receiving a floor mat therein. Other patents describe floor mats having a textured surface to prevent slipping. These devices, however, do not disclose an ornamental vehicle floor mat cover that may be easily interchanged to customize the appearance of the interior of a vehicle. The following is a list of devices deemed most relevant to the present disclosure, which are herein described for the purposes of highlighting and differentiating the unique aspects of the present invention, and further highlighting the drawbacks existing in the prior art.

For example, U.S. Pat. No. 6,224,962 to Young discloses a floor mat cover for use with a floor mat of a vehicle. The floor mat cover of Young includes top and bottom panels coupled along their outer perimeters to define a pocket therebetween for receiving a floor mat therein. The bottom panel has a longitudinal slit therethrough, defining an opening of the pocket. While the Young device describes a floor mat cover that encloses an existing vehicle floor mat, it is limited in the fact that it provides only one opening to insert a floor mat therein. This requires a user to force the entire length of the floor mat into the device. This is difficult to accomplish, as floor mats generally comprise a high friction surface to prevent shifting of the same during use. In contrast, the present invention provides two pockets, wherein each pocket has an opening to receive opposing sides of a floor mat therein. Accordingly, the present invention increases ease of use and installation, providing convenience to the user.

U.S. Pat. No. 4,596,729 to Morrison provides a non-slip floor mat assembly comprising a plurality of rectangular floor mat panels wherein the panels are coupled together to provide a single mat having a textured, non-slipping surface. Each of the floor mat panels is integrally molded and includes a textured pattern, such as parallel ridges. The purpose and design of the Morrison device, however, differs from the present invention in that the Morrison device is not designed for use in vehicles. Moreover, Morrison does not disclose a covering for the floor mat to enclose or conceal the floor mat therein. The present invention provides an ornamental cover for vehicle floor mats. Additionally, the non-slip surface of the present invention is substantially unitary in structure, thereby eliminating the need to mold individual pieces together.

Another device, U.S. Pat. No. 4,481,240 to Roth discloses a floor mat mounting system for use with vehicle floor mats. The Roth device provides a retainer having a surface on which a vehicle floor mat may be placed. In one embodiment, the surface is smooth, and is adapted to be glued or otherwise fastened to a vehicle floor mat. In another embodiment, the surface comprises a plurality of bristles adapted to engage the floor mat. Unlike the present invention, the device of Roth does not disclose an ornamental cover for existing vehicle floor mats. The present cover includes a decorative upper surface and a lower surface having pockets disposed thereon. The lower surface also comprises a high friction surface to prevent the device from shifting during use.

U.S. Pat. No. 5,021,277 to Fan discloses a tri-layer vehicle mat, wherein the top and the middle layers comprise a plurality of apertures thereon. The middle layer and the bottom layer are separated via a plurality of spacing members disposed therebetween. The top layer helps brush off any sand that is left on the bottom of the vehicle occupant's shoes. The sand passes through the apertures on the top and middle layers, so that it is collected in the bottom layer. In this way, the device of Fan prevents the sand from spreading on the floor of a vehicle. While the device of Fan protects an existing vehicle mat, the purpose and design of the Fan device differs from the present invention. The device of Fan is used in lieu of an existing vehicle floor mat, or is placed thereabove. In contrast, the present invention comprises a cover that encases the existing floor mat, while providing an aesthetic feature.

Finally, U.S. Pat. No. 6,027,781 to Landry provides a protective cover for an automotive carpet mat. The protective cover comprises a shallow tray that is sized and shaped to extend completely over the automotive carpet mat, wherein the tray is secured to the automotive carpet mat. Unlike the present invention, the Landry device protects only the top surface of an existing vehicle floor mat. Additionally, Landry does not disclose pockets for securing the floor mat. Instead, Landry discloses a flap that is integral with the periphery of the tray and extends inwardly.

These prior art devices have several known drawbacks. These devices lack aesthetic quality and are difficult to install or are otherwise inconvenient to use. The present invention provides an ornamental vehicle floor mat cover that changes the outward appearance of a conventional vehicle floor mat. The present vehicle floor mat cover provides pockets in which the existing vehicle floor mat may be easily inserted therein. It is therefore submitted that the present invention substantially diverges in design elements from the prior art, which overcomes the disadvantages of the prior art devices, and consequently it is clear that there is a need in the art for an improvement to existing vehicle floor mats. In this regard the instant invention substantially fulfills these needs.

### SUMMARY OF THE INVENTION

In view of the foregoing disadvantages inherent in the known types of vehicle floor mats now present in the prior art, the present invention provides a new improvement to an ornamental vehicle floor mat cover wherein the same can be utilized for providing an ornamental accessory for a vehicle interior while covering and protecting a vehicle floor mat.

It is therefore an object of the present invention to provide a new and improved ornamental vehicle floor mat cover that has all of the advantages of the prior art and none of the disadvantages.

It is another object of the present invention to provide a new and improved ornamental vehicle floor mat cover that is adapted to fit onto existing vehicle floor mats of various sizes to accommodate floor mats for vehicles of different make, model, and year.

Another object of the present invention is to provide a new and improved ornamental vehicle floor mat cover that changes the outer appearance of a vehicle floor mat from one that is purely utilitarian to one that is more decorative and aesthetically pleasing.

Yet another object of the present invention is to provide a new and improved ornamental vehicle floor mat cover that provides one or more pockets adapted to receive a vehicle floor mat therein.

Still yet another object of the present invention is to provide a new and improved ornamental vehicle floor mat cover having a durable, decorative surface, thereby allowing a user to customize the interior of a vehicle while providing protective features to be utilized as desired.

Still yet another object of the present invention is to provide a new and improved ornamental vehicle floor mat cover having a non-slip surface to prevent the cover from shifting on the floor of a vehicle.

Still yet another object of the present invention is to provide a new and improved ornamental vehicle floor mat cover that is cost effective way to replace a worn vehicle floor mat.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and in manner in which it may be made and used may be better understood after a review of the following description, taken in connection with the accompanying drawings wherein like numeral annotations are provided throughout.

FIG. 1 shows a top perspective view of an embodiment of the present invention.

FIG. 2 shows a bottom perspective view of an embodiment of the present invention.

FIG. 3 shows a top perspective view of a second embodiment of the present invention.

FIG. 4 shows a bottom perspective view of a second embodiment of the present invention.

FIG. 5 shows a view of a vehicle floor mat being inserted into the ornamental vehicle floor mat cover of the present invention.

### DETAILED DESCRIPTION OF THE INVENTION

Reference is made herein to the attached drawings. Like reference numerals are used throughout the drawings to depict like or similar elements of the ornamental vehicle floor mat cover. For the purposes of presenting a brief and clear description of the present invention, the preferred embodiment will be discussed as utilized for providing an ornamental accessory for a vehicle interior while covering and protecting a vehicle floor mat. The figures are intended for representative purposes only and should not be considered to be limiting in any respect.

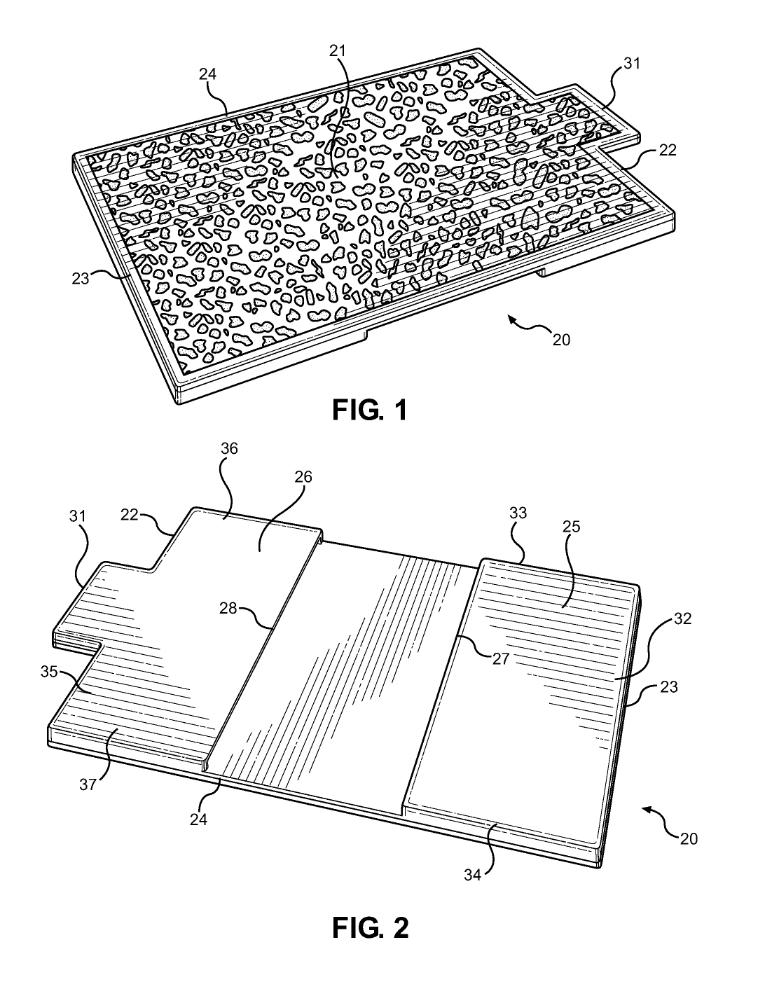

Referring now to FIG. 1, there is shown a top perspective view of an embodiment of the present invention. The ornamental vehicle floor mat cover 20 of the present invention comprises an upper layer 21 that is disposed on a lower layer 24. The cover 24 further comprises a first 22 edge opposite a second side edge 23. The upper layer 21 is dimensioned so that it does not extend past the lower layer 24. As such, the perimeter of the lower layer 24 extends outwardly further than the perimeter of the upper layer 21. In the exemplary embodiment, the ornamental vehicle floor mat cover 20 is constructed for use with a front vehicle floor mat. As such, the exemplary embodiment of the present invention is a modified rectangle having a protruding tab 31 disposed on the first edge 22, wherein the protruding tab 31 is adapted to be placed under the pedals.

The upper layer 21 comprises a top surface that is coextensive with a bottom surface. The top surface of the upper layer 21 is a tufted or woven surface comprising a planar sheet of durable carpet material, such as yarn, that may be composed of nylon, nylon blend, rayon, or other suitable material. The bottom surface of the upper layer 21 comprises one or more layers of backing material that helps keep the carpet material in place on the lower layer 24. The backing material may be composed of synthetic material such as latex. Additionally, the backing material may be specially treated so that it may be anti-microbial or stain-resistant. The bottom surface of the upper layer 21 is attached to the lower layer 24 via strong adhesive or the like.

The top surface of the upper layer 21 may comprise a wide range of patterns, themes, designs, and colors to suit the user's preference and personal style. The carpet material may be dyed topically or dyed in a molten state in a solution. Alternatively, patterns and designs may be printed directly onto the top surface of the upper layer 21. The carpet material may comprise various carpet types, such as a cut pile, loop, or combination of cut pile and loop configurations.

Referring now to FIG. 2, there is shown a bottom perspective view of an embodiment of the present invention. The lower layer 24 may be composed of durable material such as rubber, polyvinyl chloride (PVC), leather, or other suitable material. In the illustrated embodiment, the lower layer 24 comprises a first pocket 25 disposed at the second side edge 23 and a second pocket 26 disposed at the first side edge 22. The pockets 25, 26 may be composed of the same material as the lower layer 24 material. Each of the pockets 25, 26 has a defined perimeter that is shaped so as to follow the contours of the second side edge 23 and the first side edge 22 of the floor mat cover 20, respectively.

The pockets 25, 26 are separated by a space. The pocket 25 is substantially rectangular in shape, and comprises a top edge 27 opposite a bottom edge 32, and two side edges 33, 34. The top 27 and bottom edges 32 of the pocket 25 span the length of the second side edge 23. The side edges 33, 34 and the bottom edge 32 of the pocket are stitched into or affixed to the lower layer 24, leaving the top edge 27 open. Similarly, the pocket 26 is a modified rectangle having a top edge 28 opposite a bottom edge 35, and two side edges 36, 37. The top 28 and bottom edges 35 of the pocket 26 span the length of the first side edge 22. The side edges 36, 37 and the bottom edge 35 are stitched into or affixed to the lower layer 24, leaving the top edge 28 open. In this way, the opposing edges of the pockets 25, 26 are open in order to receive a vehicle floor mat therein.

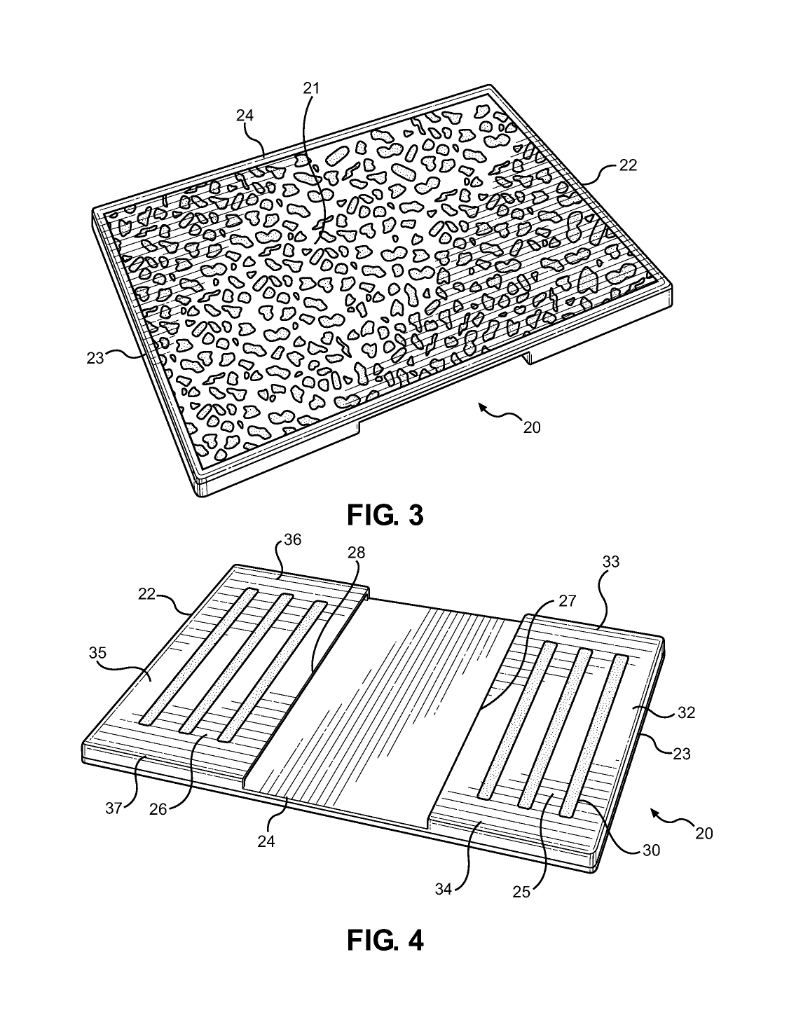

Referring now to FIG. 3, there is shown a top perspective view of a second embodiment of the present invention. The present invention may be constructed to fit various types of floor mats. In the exemplary embodiment, the ornamental vehicle floor mat cover 20 is substantially rectangular in shape and is constructed for use with a rear vehicle floor mat. As such, the exemplary embodiment of the cover 20 is adapted to be placed on the floor between the front seats and rear seats of the vehicle.

Similar to the first embodiment, the ornamental vehicle floor mat cover 20 comprises a first 22 and second side edge 23. The upper layer 21 comprises a top surface that is coextensive with a bottom surface. The upper layer 21 is dimensioned so that it does not extend past a lower layer 24. As such, the perimeter of the lower layer 24 extends outwardly further than the perimeter of the upper layer 21. The top surface of the upper layer 21 is a tufted or woven surface comprising a planar sheet of durable carpet material, such as yarn, that may be composed of nylon, nylon blend, rayon, or other suitable material. The bottom surface of the upper layer 21 comprises one or more layers of backing material that helps keep the carpet material in place. The backing material may be composed of synthetic material such as latex. Additionally, the backing material may be specially treated so that it may be anti-microbial or stain-resistant. The bottom surface is attached to the lower layer 24 via strong adhesive or the like.

The top surface of the upper layer 21 may comprise a wide range of patterns, themes, designs, and colors to suit the user's preference and personal style. It is preferred that the pattern or design of the present embodiment may be substantially identical to the pattern or design of the first embodiment so as to create a uniform appearance throughout the interior of a vehicle. The carpet material may be dyed topically or dyed in a molten state. Alternatively, patterns and designs may be printed directly onto the top surface of the upper layer 21. The carpet material may comprise various carpet types, such as a cut pile, loop, or combination of cut pile and loop configurations.

Referring now to FIG. 4, there is shown a bottom perspective view of a second embodiment of the present invention. The lower layer 24 may be composed of durable material such as rubber, PVC, leather, or other suitable material. In the illustrated embodiment, the lower layer 24 comprises a first pocket 25 disposed at the second side edge 23 and a second pocket 26 disposed at the first side edge 22. The pockets 25, 26 may be composed of the same material as the lower layer 24 material. Each of the pockets 25, 26 comprises a perimeter that is shaped so as to follow the contours of the second side edge 23 and the first side edge 22 of the floor mat cover 20, respectively.

The pocket 25 and the pocket 26 are separated by a space. The pocket 25 is substantially rectangular in shape, and comprises a top edge 27 opposite a bottom edge 32, and two side edges 33, 34. The top 27 and bottom edges 32 of the pocket 25 span the length of the second side edge 23. The side edges 33, 34 and the bottom edge 32 of the pocket 25 are stitched into or affixed to the lower layer 24, leaving the top edge 27 open. Similarly, the pocket 26 is a modified rectangle having a top edge 28 opposite a bottom edge 35, and two side edges 36, 37. The top 28 and bottom edges 35 of the pocket 26 span the length of the first side edge 22. The side edges 36, 37 and the bottom edge 35 are stitched into or affixed to the lower layer 24, leaving the top edge 28 open. In this way, the opposing edges of the pockets 25, 26 are open in order to receive a vehicle floor mat therein.

Additionally, the pockets 25, 26 may further comprise a textured surface to prevent the cover 20 from shifting while in use. Alternatively, the pockets 25, 26 may have a plurality of ridges or treading 30 thereon. The ridges or treading 30 may be removably attached via hook and loop fasteners, adhesives, or by other suitable means so that it may be added as desired or required by the user.

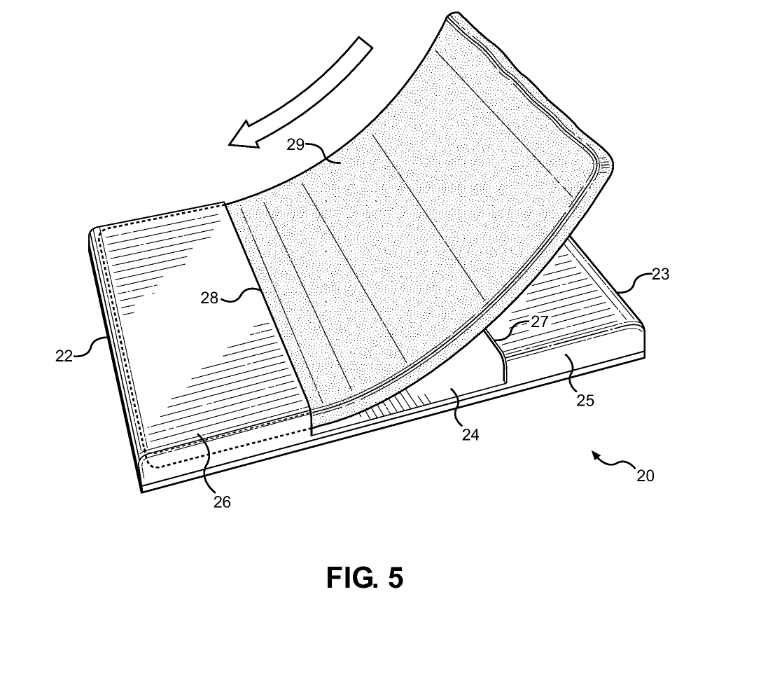

Referring now to FIG. 5, there is shown a view of a floor mat 29 of a vehicle being inserted into the ornamental vehicle floor mat cover 20 of the present invention. The cover 20 of the present invention is flexible so that it can bend to receive a vehicle floor mat 29 therein. Each of the first 22 and second side edges 23 of the cover 20 provide a pocket 25, 26, which fits over two opposing ends of the vehicle floor mat 29. In the illustrated view, one end of the vehicle floor mat 29 is inserted through the opening 28 and pushed towards the first side edge 22. The remaining portion of the vehicle floor mat 29 is bent and inserted through the opening 27 and towards the second side edge 23. Thereafter, the vehicle floor mat 29 is pressed flat against the lower layer 24.

The cover 20 is adapted to fit snugly over the vehicle floor mat 29. In some embodiments, the cover 20 may be stretched so that the cover 20 and the vehicle floor mat 29 are brought closely together, and thus cover 20 is maintained on the vehicle floor mat 29 with a tight fit. In this way, the cover 20 is prevented from gapping or loosening on the vehicle floor mat 29 or at any part thereof. In other embodiments, the cover 20 may further comprise a fastener such as hook and loop fasteners, snaps, hooks, buttons, or other suitable fastening means to securely hold the vehicle floor mat 29 therein.

Once affixed, the cover 20 is securely constrained to the vehicle floor mat 29, resisting separation or relative sliding during use. The cover 20 does not affect the functionality of the vehicle floor mat 29, but acts in place of the existing vehicle floor mat 29. In its operating state, the lower surface 24 of the cover 20 rests on the floor of a vehicle, similar to the intended position of the vehicle floor mat 29. In this way, the cover 20 protects the floor of the vehicle from dirt, debris, and wear. Therefore, the present invention does not detract from its goal of protecting the floor of a vehicle. When the cover 20 is no longer needed or desired, it can be easily pulled off of the vehicle floor mat 29 and stored without any inconvenience to the user. Alternatively, the cover 20 may be interchangeable so that another cover 20 may be used to alter the appearance of the interior of a vehicle. Furthermore, the present cover 20 may be used with various types of surface covering devices such as seat cushions and the like.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A decorative vehicle floor mat cover, comprising:
an upper layer having a top surface that is coextensive with a bottom surface;
a lower layer having a top surface and a bottom surface;
said bottom surface of said upper layer attached to said top surface of said lower layer;
at least one pocket disposed on said bottom surface of said lower layer, wherein said least one pocket is adapted to receive an end of a vehicle floor mat therein.

2. The vehicle floor mat cover of claim 1, wherein said top surface of said upper layer comprises a carpet material.

3. The vehicle floor mat cover of claim 1, wherein said lower layer is composed of non-slip material to prevent said lower layer from slipping.

4. The vehicle floor mat cover of claim 1, wherein said least one pocket further comprises at least one removable treading.

5. The vehicle floor mat cover of claim 1, wherein a perimeter of said lower layer extends outwardly further than a perimeter of said upper layer.

6. The vehicle floor mat cover of claim 1, wherein said top surface of said upper layer comprises a printed design.

7. The vehicle floor mat cover of claim 1, wherein said lower layer further comprises
a top edge, a bottom edge, a first side edge, and a second side edge;
each of said first and second side edge of said lower layer having a pocket disposed thereon;
said pocket having a top edge, a bottom edge, and a first side edge opposite a second side edge;
said first side edge of said pocket attached to said top edge of said lower layer;
said second side edge of said pocket attached to said bottom edge of said lower layer;
said bottom edge of said pocket attached to said first side edge of said lower layer, leaving said top edge of said pocket open.

8. The vehicle floor mat cover of claim 1, wherein said lower layer further comprises
a top edge, a bottom edge, a first side edge, and a second side edge;
each of said first and second side edge of said lower layer having a pocket disposed thereon;
said pocket having a top edge, a bottom edge, and a first side edge opposite a second side edge;
said first side edge of said pocket attached to said top edge of said lower layer;
said second side edge of said pocket attached to said bottom edge of said lower layer;
said bottom edge of said pocket attached to said second side edge of said lower layer, leaving said top edge of said pocket open.
